(19) United States
(12) Patent Application Publication
(10) Pub. No.: US 2008/0173625 A1
(43) Pub. Date: Jul. 24, 2008

(54) Welding Head

(75) Inventor: Stefan Hofmann, Wetzlar (DE)

Correspondence Address: HARNESS, DICKEY & PIERCE, P.L.C., P.O. BOX 828, BLOOMFIELD HILLS, MI, 48303, US

(73) Assignee: Newfrey LLC, Newark, DE (US)

(21) Appl. No.: 11/944,648

(22) Filed: Nov. 26, 2007

(30) Foreign Application Priority Data
Nov. 30, 2006 (DE) DE10 2006058180.6

(51) Int. Cl. B23K 9/20

(52) U.S. Cl. 219/130.1

(57) ABSTRACT

A welding head for a welding device is operable to weld a component which is not rotationally symmetrical onto a workpiece. A head attachment includes a holding device for holding the component and to carry a welding current to the component. A mouthpiece is arranged around the holding device and the component during a welding operation. The holding device and the mouthpiece move in relation to each other along a welding axis. The mouthpiece contacts the workpiece and provides a protective gas tangentially about the welding component. An interface device supplies the welding current to the holding device. A connecting device mechanically connects the holding device to the interface device. The connecting device is subdivided into a first connection piece connected to the holding device and a second connection piece electrically insulated from the first connection piece.

### CROSS-REFERENCE TO RELATED APPLICATIONS

This application is a continuation of German Patent Application No. 10 2006 058 180.6, filed Nov. 30, 2006. The disclosure of the above application is incorporated herein by reference.

### FIELD

The present invention relates to a welding head.

### BACKGROUND

Such a welding head such as that known from DE 10 2004 060 389 A1 may serve for welding metallic components that are not rotationally symmetrical (for example holders, earth flanges or the like) onto metallic workpieces, such as for example body sheets of motor vehicles. The component generally has in this case a welding surface which is much longer in one direction than in the direction transverse thereto.

The basic technology for this type of welding process corresponds to what is known as stud welding. The welding-on operation is consequently performed with preference by the rapid drawn-arc method with magnetic arc deflection.

Devices for drawn-arc welding by means of magnetic arc deflection have long been known and have proven successful in practice. For example, U.S. Pat. No. 2,406,474 from 1946 already shows a device and a circuit for stabilizing a welding arc. For this purpose, the invention uses a coil with a winding which is connected in series to the conductor of the welding current. This has the consequence that a magnetic field is formed at the same time as the welding current flows. The stud holder, which is located in the centre of the coil, serves as a coil core.

In U.S. Pat. No. 2,413,189 shows a device for welding studs which is intended for manual use. The document also shows that it is necessary to make the supply lead for the welding current flexible, since it is necessary according to the method to move the stud holder away from the workpiece in a lifting movement.

DE 1 565 003 likewise shows a device for welding fastening elements by arc stud welding on the drawn-arc principle. In this device too, a coil comprising a winding is connected in series to the welding current and arranged around the welding location. The purpose of these devices is, on the one hand, to avoid a blasting effect of the arc and, on the other hand, to produce rotation of the arc when welding tubular components (fastening elements).

DE 102 53 415 discloses a method and a device for welding on rectangular sheetmetal brackets. This device likewise has a coil arrangement, which is intended to produce a linear movement of the arc. By contrast with the documents mentioned further above, in this case the coil arrangement is not connected in series with the welding current.

The use of protective gas by means of directing it as a stream is disclosed in DE 196 38 287. Here, protective gas is directed onto the joining location from the side and makes oxide-free soldering possible, since the ambient air is blown away by the stream applied.

However, a disadvantage of the aforementioned methods and devices is that cables carrying welding current have to be laboriously led out from the device housing into the front welding region. The rigidity and, most particularly, the inert mass of these welding-current-carrying cables, which have to be relatively sturdy on account of the high current intensity, lead to hindrances in the sequences of movements. In the case of arc stud welding by the drawn-arc method, reciprocating movements take place in the range of milliseconds and therefore represent highly dynamic processes.

### SUMMARY

On the basis of this knowledge, an object of the present invention is to provide a welding head of the simplest construction and low mass which preferably also has a magnetic coil of the simplest possible construction which is fed by the welding current and for which a small inert mass suffices.

A further object of the invention is to provide a device which, by the way it directs protective gas, enhances the welding characteristics when welding bracket-type holders.

The above objects and/or further objects are achieved by welding heads such as those defined in the claims. The subjects described there can be combined with one another as desired.

Preferred refinements can be found in the subclaims.

It goes without saying that the features mentioned above and those still to be explained can be used not only in the combinations specified but also in other combinations or on their own without departing from the present invention.

### DRAWINGS

Exemplary embodiments of the invention are explained in more detail in the description which follows and are represented in the drawings, in which:

FIG. 1 is a front elevational view of a welding device with a welding head according to one embodiment of the invention;

FIG. 2 is a side elevational view of the welding device of FIG. 1;

FIG. 3 is a longitudinal cross sectional view through a head attachment of the welding head shown in FIGS. 1 and 2; and

FIG. 4 is a side perspective view of the head attachment of FIG. 3.

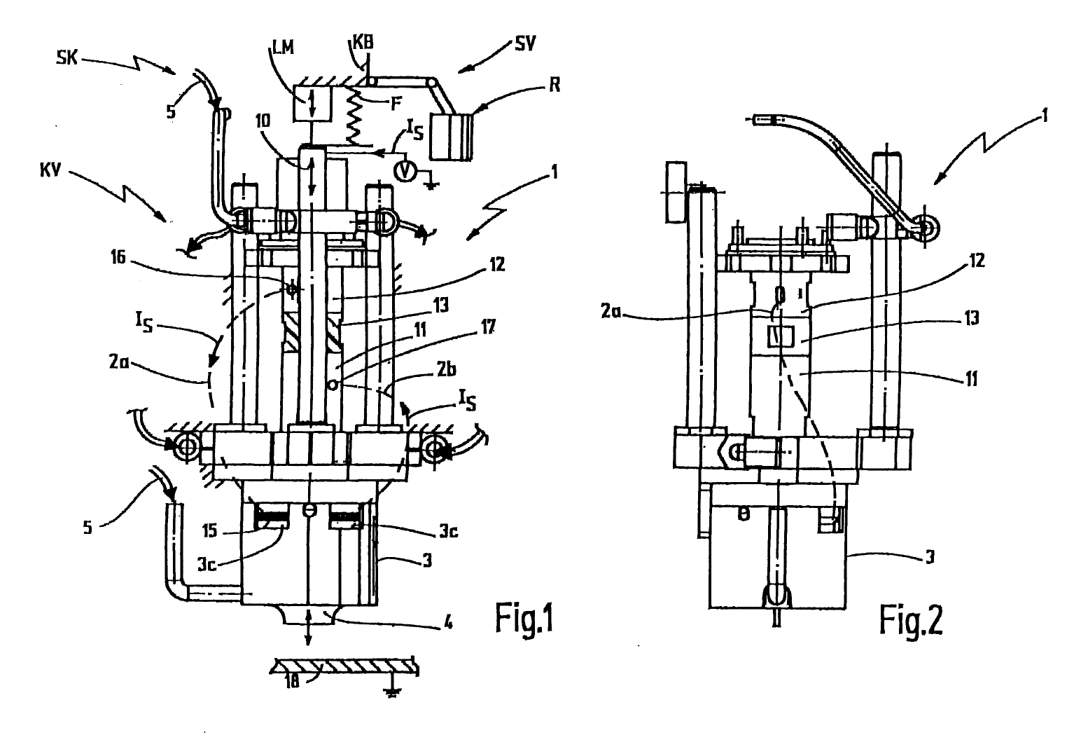

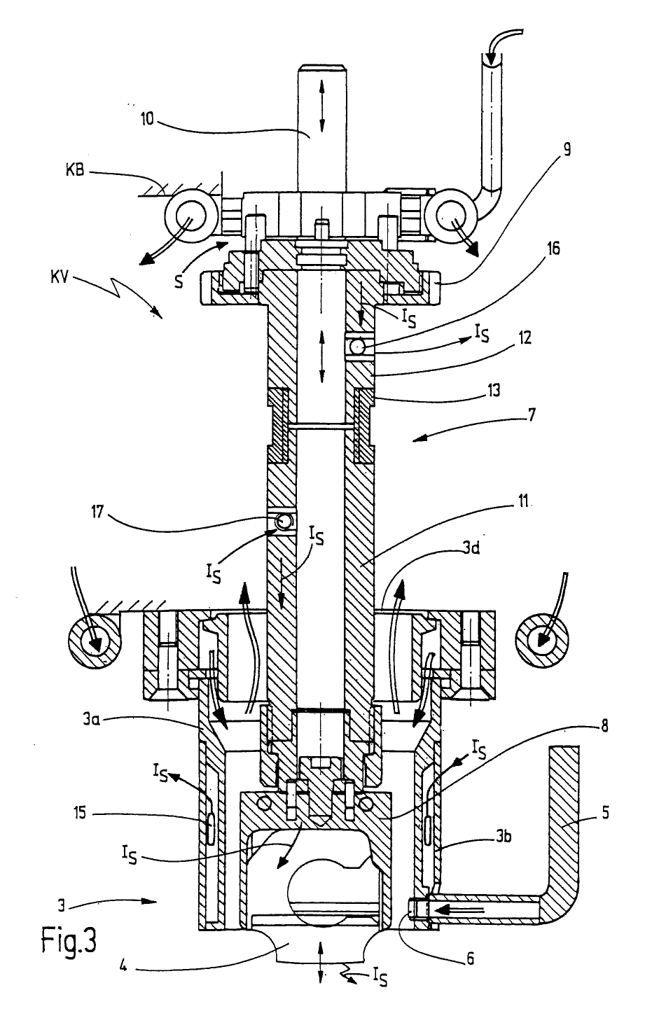

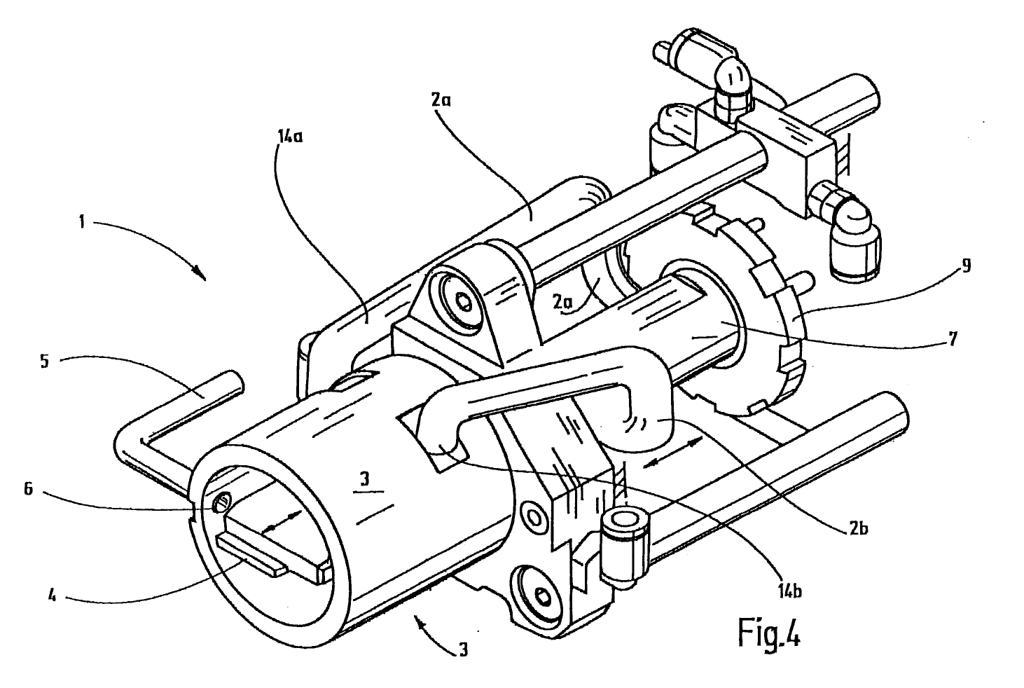

### DETAILED DESCRIPTION

The front end or head attachment 1 according to the invention for a welding head SK has a protective gas mouthpiece 3 and a connecting device (a connecting flange) 7. The head attachment KV can be connected to the head base KB by means of an interface device S. The connecting device has connection pieces 11 and 12, which are insulated from each other by an insulating piece 13 mechanically connecting them. Arranged at the lower end of the connection piece 11 is the welding element holder 8 (holding device), which is located centrally in the protective gas mouthpiece 3 and centrally surrounded by a MAC coil 15, the coil being arranged within an outer wall 3b of the mouthpiece 3. The mouthpiece 3 is of a multipart form, with an inner part 3a, within which a welding element or component 4 is held and on the outer side of which the coil device 15 is arranged, and with an outer part 3b, which encloses the coil device 15 and forms the outer wall of the mouthpiece 3.

At the lower end of the protective gas mouthpiece 3 there is a first protective gas supply 5 for the protective gas necessary for welding. This is introduced into the interior space in such a way that the protective gas stream flows tangentially along the welding element 4 to be welded. This type of protective gas supply has the advantage that there is always an adequate amount of gas available to allow the welding area to be reliably covered. On account of the fact that the stream of protective gas is relatively stable (stiff) as a result of the volumetric flow, the welding location is also effectively protected from ambient influences such as drafts.

It has been found in tests that it is appropriate under some circumstances to provide two outlet openings 6, which may be arranged opposite each other. This is expedient whenever a particularly high volumetric flow is required. Furthermore, protective gas may be additionally directed from above into the inner mouthpiece 3. The gas displaced out of the mouthpiece is discharged via an upper opening 3d.

The current I_{S}, required for the welding process is introduced into the connecting flange 7 via a connection shank 10 of the interface device S, to be precise into the upper connection piece 12. To introduce the current into the coil 15, the current is taken from the connection point 16 of the connection piece 12 and passed to the coil input 14a of the MAC coil 15 via the welding current cable 2a. In the coil 15, the current passes through at least one winding and is picked off again at the coil input 14b and returned to the connecting flange 7, but via a connecting point 17 to its lower connection piece 11. This is electrically connected to the holding device 8, and consequently to the component 4.

If a welding process is initiated, the welding head SK moves together with the front end 1 towards the workpiece 18. The welding element 4 comes into contact and a monitoring signal can be detected (here: low voltage in the short-circuit). The mouthpiece 3 sets down on the workpiece 18. Subsequently, the welding process is initiated, having the effect firstly that protective gas flows onto the welding location. With a brief delay, a pilot arc is struck. After switching on the pilot current, the welding element 4 is lifted off from the workpiece 18, by means of the drive device LM. An arc forms. As soon as it is stable, the welding current is switched on.

As already mentioned further above, the current is looped through the coil 15 before it reaches the welding element 4. This has the advantage in particular that the magnetic field forms synchronously with respect to the welding current I_{S}. If an alternating current source is used, the direction of the field changes and a moving arc is additionally obtained. In the case represented with a welding element 4 of a rectangular cross section, the arc would migrate along the underside of the welding flange in the form of a figure of eight on its side.

From a purely functional and mechanical viewpoint, the way in which the current is led through according to the invention has the further advantage that the disruptive contours become many times smaller. Furthermore, it is no longer necessary to lead the thick and inflexible welding current cable out of the housing of the welding head SK or a welding gun and wind them around the protective gas mouthpiece. When the front end 1 is changed, for example because of a repair or because of a refit, it is possible as in the case of conventional welding heads for the drawn-arc welding method variant to exchange the front end without laboriously having to remove welding current cables. If it is just required to exchange the protective gas mouthpiece 3, as a result of a collision etc. all that is necessary is to disconnect the connections of the welding current cables 2a and 2b and this allows the mouthpiece to be unscrewed. It follows from this that the welding head according to the invention is also very easy to maintain.

What is claimed is:

1. A welding head for a welding device, the welding head adapted for welding a component which is not rotationally symmetrical onto a workpiece, comprising:
a head attachment having:
a holding device for holding the component and adapted to carry a welding current to the component; and
a mouthpiece arranged around the holding device and the component during a welding operation, the holding device and the mouthpiece adapted to move in relation to each other along a welding axis, the mouthpiece adapted to contact the workpiece and provide a protective gas tangentially about the welding component;
an interface device adapted to supply the welding current to the holding device; and
a connecting device mechanically connecting the holding device to the interface device, the connecting device subdivided into a first connection piece connected to the holding device and a second connection piece electrically insulated from the first connection piece.

2. The welding head according to claim 1, further comprising a head base, wherein the head attachment includes a fixed portion rigidly connected to the head base and the mouthpiece.

3. The welding head according to claim 2, comprising a movable part of the head attachment movable with respect to the head base, the movable part receiving the welding current via the interface device and mechanically fixed to a drive device for driving the movable part at least in a welding direction.

4. A welding head for a welding device for welding a component which is not rotationally symmetrical onto a workpiece including a metal sheet, comprising:
a head base;
a head attachment connected to the head base by a drive device operable to move the head attachment with respect to the head base, the head attachment including:
a holding device for temporarily holding the component for welding and adapted for carrying a welding current to the component; and
a mouthpiece arranged to surround the component during a welding operation, the holding device and the mouthpiece movable in relation to each other along a welding axis;
an interface device;
a connecting device, the holding device mechanically connected by the connecting device to the interface device, the connecting device operating to supply the welding current, the connecting device subdivided into a first connection piece and a second connection piece electrically insulated from the first connection piece.

5. The welding head according to claim 4, comprising:
a coil device having a first electrical connection;
wherein the first connection piece is electrically connected to the first electrical connection of the coil device permitting the welding current to be conducted from the interface device via the first connection piece into the coil device.

6. The welding head according to claim 5, comprising:
a second electrical connection of the coil device;
wherein the second connection piece is electrically connected to the holding device and to the second electrical connection of the coil device such that the welding current is conducted from the coil device via the second connection piece and the holding device into the component.

7. The welding head according to claim 5, comprising a welding current cable, wherein at least one of the first and second connection pieces is connected via the welding current cable to the coil device which is fixed on the mouthpiece, the welding current cable inserted into the mouthpiece at a region of the mouthpiece away from a contact location between the workpiece and the component.

8. The welding head according to claim 4 wherein the first and second connection pieces are aligned with each other in a direction of the welding axis.

9. The welding head according to claim 4, comprising an electrical insulating piece, wherein the first and second connection pieces are electrically insulated from each other by the electrical insulating piece, the electrical insulating piece adapted to mechanically connect the first and second connection pieces.

10. A welding head for a welding device for welding a component which is not rotationally symmetrical onto a workpiece including a metal sheet, comprising:
a head base;
a head attachment connected to the head base by a drive device operable to move the head attachment with respect to the head base, the head attachment including:
a holding device for temporarily holding the component for welding and adapted for carrying a welding current to the component; and
a mouthpiece arranged to surround the component during a welding operation, the holding device and the mouthpiece movable in relation to each other along a welding axis; and
a coil device having at least one winding, the coil device positioned within an outer wall of the mouthpiece.

11. The welding head according to claim 10, wherein the mouthpiece includes an annular space having the coil device arranged within the annular space.

12. The welding head according to claim 10, wherein the mouthpiece further includes an inner part and an outer part, the component being held within the inner part, the inner part having an outer side with the coil device positioned between the outer side and the outer part, the outer part forming an outer wall of the mouthpiece which encloses the coil device, the annular space defined between the inner part and the outer part.

13. The welding head according to claim 12, wherein the outer part includes at least one clearance adapted for receiving and leading through a welding current cable.

14. The welding head according to claim 10, further comprising:
an interface device; and
a connecting device, the holding device mechanically connected by the connecting device to the interface device, the connecting device operating to supply the welding current, the connecting device subdivided into a first connection piece and a second connection piece electrically insulated from the first connection piece.

15. A welding head for a welding device for welding a component which is not rotationally symmetrical onto a workpiece including a metal sheet, comprising:
a head base;
a head attachment connected to the head base by a drive device operable to move the head attachment with respect to the head base, the head attachment including:
a holding device for temporarily holding the component for welding and adapted for carrying a welding current to the component; and
a mouthpiece arranged to surround the component during a welding operation, the holding device and the mouthpiece movable in relation to each other along a welding axis; and
a protective gas supply device positioned proximate the mouthpiece and having at least one nozzle arranged to blast the component within the mouthpiece tangentially with a protective gas.

16. The welding head according to claims 15, wherein the head attachment includes an upper opening adapted to discharge the protective gas from the mouthpiece.

17. The welding head according to claim 15, further comprising:
an interface device; and
a connecting device, the holding device mechanically connected by the connecting device to the interface device, the connecting device operating to supply the welding current, the connecting device subdivided into a first connection piece and a second connection piece electrically insulated from the first connection piece.

18. A welding head for a welding device for welding a component which is not rotationally symmetrical onto a workpiece including a metal sheet, comprising:
a head base;
a head attachment connected to the head base, the head attachment including:
a holding device for temporarily holding the component for welding and adapted for carrying a welding current to the component; and
a mouthpiece arranged to surround the component during a welding operation, the holding device and the mouthpiece movable in relation to each other along a welding axis; and
a protective gas supply device arranged at the mouthpiece, the protective gas supply device having at least one supply channel which is led from outside the mouthpiece into an interior of the mouthpiece at a lower, workpiece contacting region of the mouthpiece.

19. The welding head according to claim 18, wherein the head attachment includes a fixed portion rigidly connected to the head base.

20. The welding head according to claim 19, further comprising:
an interface device; and
a connecting device, the holding device mechanically connected by the connecting device to the interface device, the connecting device operating to supply the welding current, the connecting device subdivided into a first connection piece and a second connection piece electrically insulated from the first connection piece by an insulating piece.

21. The welding head according to claim 20, comprising a part of the head attachment movable with respect to the head base and operable to receive the welding current via the interface device.

22. The welding head according to claim 21, wherein the head attachment is connected to the head base by a drive device operable to move the head attachment with respect to the head base
